(19) United States
(12) Patent Application Publication
(10) Pub. No.: US 2007/0005814 A1
(43) Pub. Date: Jan. 4, 2007

(54) Device and method for classifying two-state variables of a cyclically-operating system comprising subunits

(76) Inventors: Didier Willaeys, Noyelles Sur Escaut (FR); Abdallah Asse, Wattignies (FR)

Correspondence Address: LADAS & PARRY LLP, 224 SOUTH MICHIGAN AVENUE, SUITE 1600, CHICAGO, IL, 60604, US

(21) Appl. No.: 10/556,582

(22) PCT Filed: May 11, 2004
(86) PCT No.: PCT/FR04/01148

§ 371 Date: Jan. 20, 2006

(30) Foreign Application Priority Data
May 14, 2003 (FR) 03/05793

(51) Int. Cl. G06F 3/00

(52) U.S. Cl. 710/2; 710/19

(57) ABSTRACT

The invention relates to a device and method for classifying two-state variables of a cyclically-operating system comprising subunits. The inventive method comprises the following steps: a recording step consisting in recording dated state changes noted for each of the variables during a determined time T; a calculation step consisting in using the aforementioned dated state changes in order to determine, for each of the variables, (i) the different durations (D1) between two consecutive passages to a first state (E1) and (ii) the different durations (D2) between two consecutive passages to a second state (E2), such as to create duration lists (LD1) and (LD2); and a processing step consisting in, for each variable, comparing the different duration lists (LD1) and/or (LD2) to the different duration lists (LD1) and/or (LD2) for the other variables and the number of occurrences thereof, such as to classify said variables into groups, whereby each group corresponds to at least one of the subunits of the system.

The invention is particularly intended for the field of controlling industrial facilities notably driven by wired or programmed logic controllers.

However, although particularly intended for such applications, the invention may also be used in very many other fields where one seeks to link and classify variables of a cyclically-operating system according to subunits of said system.

Presently, the majority of industrial facilities are driven by controllers. The latter comprise an input module for monitoring the state of the variables corresponding to the sensors of the system of the driven industrial facility and an output module for controlling the actuators of said system. These input/output modules are connected on a peripheral bus connected to a central processing unit delivering commands for controlling said system.

Devices or interfaces are already known from notably Patent FR N^{o} 2,688,908, providing for communication with programmable controllers, these devices or interfaces include means for recording and dating the state of the variables of a system. This being the case, none of the known devices or interfaces allow the variables to be classified by group each corresponding to one or several subunits of the system.

Now the classification of variables into groups proves to be very useful notably for optimizing operation of the facility as it allows an analysis of the operations of each subunit and of the subunits together.

In practice, when it is necessary to group together the variables of a same subunit of the system, the recording of the states of the variables serves as a basis for the operator and from knowing or observing the system, he/she empirically manages to link up the sensors and their variables into subunits. This operation, for which there is no standard procedure, is all the longer since the complexity of the operating cycles of each subunit is higher or the number of variables is larger.

Moreover, in many cases, the system of the facility is partly or totally hidden which makes the task of the operator all the more complicated and may impose the disassembling of at least one portion of the facility.

The object of the present invention is to overcome the aforementioned drawbacks and to propose a method for classifying two-state variables of a cyclically-operating system including subunits wherein the classification of the variables into groups is automated.

Another object of the present invention is to propose a classification method with which the subunit(s) of the relevant group may be determined in the case of failure or malfunction of the system.

Another object of the present invention is to propose a classification method with which the beginning and the end of the operating cycle of each subunit may be determined.

Another object of the present invention is to propose a classification method with which the duration of working times and loading times of each subunit may be determined.

Another object of the present invention is to propose a classification device for implementing the method as an interface which may be connected or integrated to a controller.

Thus, the object of the invention is a method for classifying two-state variables of a cyclically operating system including subunits. According to the invention the following steps are achieved in said method:
a recording step wherein dated state changes of each of said variables are recorded during a determined time T,
a calculation step wherein from the dated state changes, and for each of the variables, the different durations D1 between two consecutive passages to a first state (E1) on the one hand, and the different durations D2 between two consecutive passages to a second state (E2) are determined, in order to create duration lists LD1 and LD2,
a processing step wherein for each variable, the different duration lists LD1 and/or LD2 are compared to the different lists of durations LD1 and/or LD2 of the other variables and the number of occurrences thereof so as to classify said variables in groups each corresponding to at least one of the subunits of said system.

The invention is further directed at a classification device for implementing the method, said device including:
recording means for recording and dating the state changes of each of said variables during a determined time T,
calculation means for determining from the dated state changes, and for each of the variables, the different durations D1 between two consecutive passages to a first state (E1) of a variable on the one hand, and the different durations D2 between two consecutive passages to a second state (E2) of a variable on the other hand, in order to create duration lists LD1 and LD2,
processing means for comparing for each variable the different durations D1 and/or D2 to the different lists of durations LD1 and/or LD2 of the other variables and the number of occurrences thereof in order to classify said variables in groups each corresponding to at least one of the subunits of said system.

Other features and advantages of the invention will become more apparent upon reading the description hereafter of a preferred exemplary embodiment, wherein the description is only given as a non-limiting example, and with reference to the appended drawings wherein:

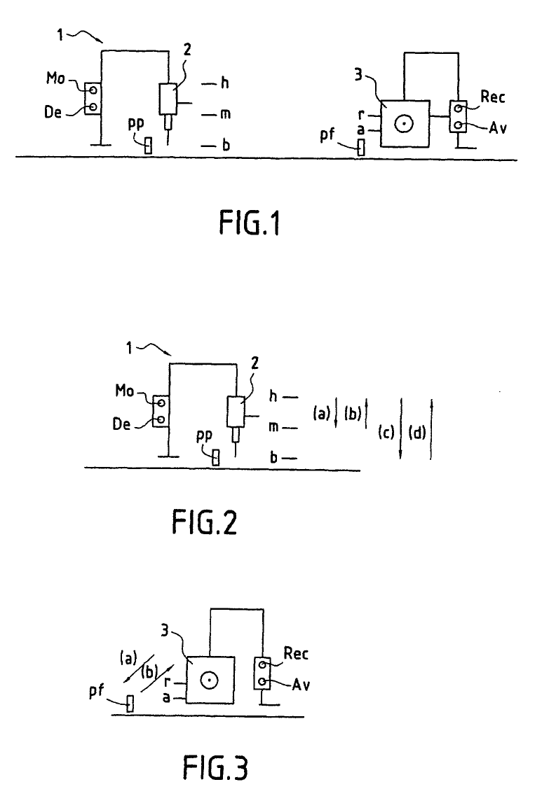

FIG. 1 schematically illustrates a facility with a system including two subunits,

FIG. 2 illustrates an example of the different successive movements of the elements of a first subunit of the facility,

FIG. 3 illustrates different successive movements of the elements of a second subunit of the facility,

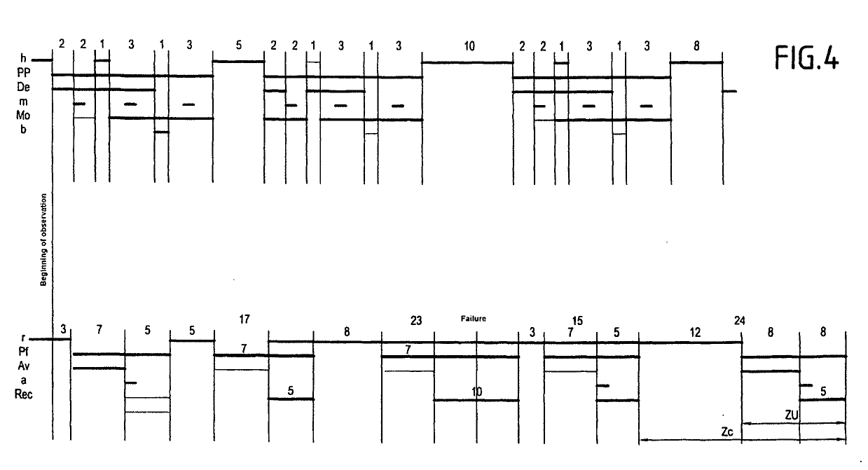

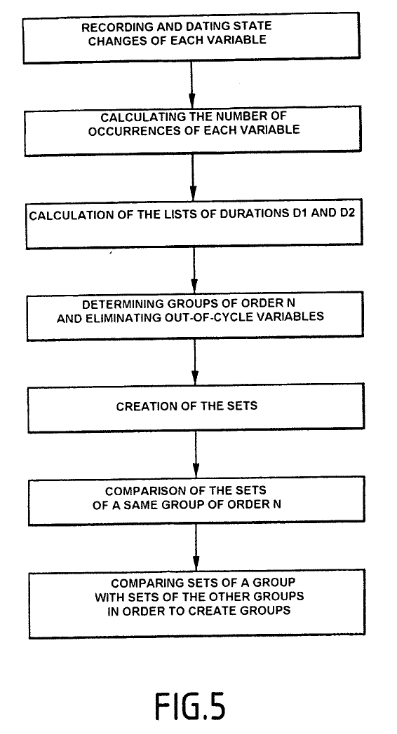

FIG. 4 illustrates an exemplary time diagram of the facility obtained by the method according to the invention,

FIG. 5 schematically illustrates a first succession of steps of the method according to the invention,

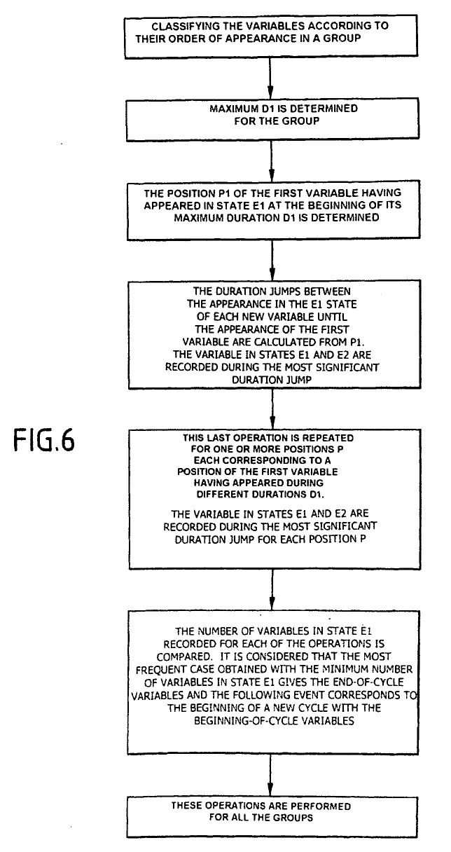

FIG. 6 schematically illustrates a second succession of steps of the method according to the invention.

The classification device and method are suitable for facilities including a complex system. This being the case, in order to facilitate the understanding of the different steps of the method, the exemplary embodiment, which is only provided as a non-limiting example, is based on a relatively basic facility.

Thus, with reference to FIG. 1, the facility 1 includes two subunits, a drill 2 and a milling machine 3.

According to the example of FIG. 1, said drill 2 has two controls, one for moving upwards Mo, and one for moving downwards De. The drill 2 is also associated with three position sensors, a high, medium and low sensor, h, m and b, respectively, and a sensor pp for sensing the presence of the part to be machined.

Referring to FIG. 2 more particularly, the cycle of the drill 2 consists of performing, according to the state of the sensor pp, a downward movement from the high position to the medium position, and then moving back up to the high position and moving downwards are far as a low position and moving back up to the high position.

According the example of FIG. 1, the milling machine 3 also has two controls, one for moving forwards Av and one for moving backwards Rec. The milling machine 3 is associated with two position sensors, a sensor a corresponding to a forward position and a sensor r corresponding to a backward position. The milling machine 3 is further associated with a sensor pf for sensing the presence of the part to be machined.

Referring this time to FIG. 3, the cycle of the milling machine 3 consists of performing, according to the state of the sensor pf, a forward movement as far as said forward position, and backward movement as far as said backward position.

With the classification method according to the invention the variables Mo, De, pp, h, m, b, pf, Av, Rec, a and r, may be classified in groups corresponding to two subunits, that of the drill 2 and that of the milling machine 3 from the sole dated states of the variables.

For this purpose, the method includes a recording step wherein the dated state changes of each of said variables are recorded during a determined time T. This time T depends on the operating cycle times of the subunits and should be sufficient to allow the recording of the variables for at least two operating cycles of each subunit. In practice, time T may allow the variables to be recorded for a significant number of operating cycles of each subunit.

FIG. 4 illustrates an exemplary time diagram of the facility wherein the set of state changes of the different variables is again found.

This time diagram will subsequently be used in order to understand the operation of the method for classifying the variables, however, in practice, the data will be recorded by recording means in view of their being automatically processed, their display as a time diagram being optional.

The classification method further comprises a calculation step wherein from the dated state changes and for each of the variables, the different durations D1 between two consecutive passages to a first state (E1) on the one hand, and the different durations D2 between two consecutive passages to a second state (E2) on the other hand, are determined in order to create duration lists LD1 and LD2.

By again taking the example of the facility of FIG. 1 and the time diagram of FIG. 4 wherein the durations D1 and D2 respectively correspond to the duration between consecutive passages to 1 on the one hand, and to 0 on the other hand, the following duration lists LD1 and LD2 are obtained by the computing step for each variable:

LD1.

Mo=(6, 11, 6, 16, 6)

De=(4, 13, 4, 18, 4, 16, 4)

pp=(17, 22, 20)

h=(8, 9, 8, 14, 8)

m=(4, 4, 9, 4, 4, 14, 4, 4, 12)

b=(17, 22, 20)

Av=(17, 20, 20, 24)

Rec=(17, 20, 20, 24)

a=(17, 20, 20, 24)

r=(15, 17, 25, 15, 24)

pf=(17, 20, 20, 24)

LD2

Mo=(8, 9, 8, 14, 8)

De=(6, 16, 6, 16, 6)

pp=(17, 22, 20)

h=(4, 13, 4, 18, 4, 16)

m=(4, 4, 9, 4, 4, 14, 4, 4, 12)

b=(17, 22, 20)

Av=(17, 20, 20, 24)

Rec=(17, 25, 15, 24)

a=(17, 20, 20, 24)

r=(p17, 20, 20, 24)

pf=(17, 25, 15, 24)

According to the invention, the classification method comprises a processing step wherein for each variable the different lists of durations LD1 and/or LD2 are compared to different lists of durations LD1 and/or LD2 of the other variables, and the number of occurrences thereof in order to classify said variables into groups each corresponding to at least one of the subunits of said system.

With reference to FIG. 5, illustrating a first succession of steps, it is seen that the processing step comprises different operations and notably one for determining groups of order n, one for creating sets, one for comparing sets of a same group of order n, and one for comparing sets of a group with the sets of the other groups.

Said processing step begins with an operation for creating at least one group of order n, each group including one or a set of variables with a close number of occurrences.

Each group is formed by counting the number of occurrences of each variable. When two variables have a number of occurrences more or less identical with a number X of occurrences, they are placed in the same group.

In the example of the facility 1 described above, by recording during a period corresponding to C operating cycles, a number of occurrences close to C will be obtained for b, pp, pf, Av, Rec, a and r, a number of occurrences close to 2C for Mo, De, h and a number of occurrences close to 3C for m.

It is considered that the number of reference cycles is the number of occurrences of the variables of the most significant group.

At this level, providing an operation for eliminating possible out-of-cycle variables may be contemplated. These may notably be variables reporting the activity of subsidiary elements such as indicator lights in an industrial facility. For this purpose, in a preferred embodiment, the set of variables for which the number of occurrences is larger than k times the number of reference cycles or less than k′ times this reference number may be eliminated.

When the groups are formed, it is considered that the group including the smallest number of occurrences is of order 1, an order n is then assigned to the other groups, such that the average number of occurrences of a group of order n is equal to n times the number of occurrences of the group of order 1.

If one or more groups are not multiples of the group of order 1, another group list is created and for each other group list, the same operations are performed as for the set of the groups of a same list.

In the example of the facility 1, three groups are found:
a group G1 of order 1 grouping the variables with a number of occurrences close to 1C: b, pp, pf, Av, Rec, a and r,
a group G2 of order 2 grouping the variables with a number of occurrences close to 2C: Mo, De, h,
a group G3 of order 3 grouping the variables with a number of occurrences close to 3C: m.

The processing step further comprises for each group an operation for creating at least one set in which the variables are linked.

A set is created by comparing in each group, the LD1 and/or LD2 terms of each variable, with the terms of the same row in the LD1 and/or LD2 of the other variables. A set is formed with the variables for which the lists are identical and it may consist of a single isolated variable.

It is considered that two lists of two variables are identical if the durations of the terms of each row are identical to within plus or minus ? or if the difference is ?, and then −? at the following row and again becomes identical to within plus or minus ?.

At this level, it is important to emphasize that in a preferred embodiment, the comparisons between two variables in order to create sets in a same group or sets of a same group together, or even sets of different groups, are performed by achieving with the processing means:
a comparison between the list LD1 of one variable and the list LD2 of the other variable,
a comparison between the lists LD1 of one variable and LD1 of the other variable,
a comparison between the lists LD2 of one variable and LD2 of the other variable.

This being the case, in other embodiments, it is conceivable not to perform these three comparisons, and for example only to compare the list LD1 of one variable with the list LD2 of the other variable.

By again taking the example, in group G1, the list LD1 of one variable is compared with the list LD2 of another variable, and two sets are obtained.

The first set EN1 groups variables b and pp, the second EN2 groups variables pf, Av, Rec, a and r.

Example of identical lists:

LD1 (b)=17, 22, 20 and LD2 (pp)=17, 22, 20, therefore b and pp belong to the same set,

LD1 (a)=17, 20, 22, 24 and

LD2 (Rec)=17, 25(20+5), 15(20−5), 24 with ?=5, therefore a and Rec belong to the same set.

Next, the comparison between the lists LD1 of one variable and LD1 of the other variables and then LD2 of one variable and LD2 of another variable is performed, by which the sets may be confirmed and possibly two sets may be linked together.

Next, one proceeds in the same way for the other groups and a single set EN3 grouping variables h, De, and Mo is obtained for group G2 and a set EN4 is obtained for group G3 which only contains a single variable.

Said processing step further includes an operation for comparing each set in a same group and the union of the sets when two variables each belonging to one of the sets are linked.

The comparison between sets of a same group is performed by calculating lists LDd of shifted durations. These lists LDd are obtained by removing the first row term for example from a list LD1 and by shifting the other values by one row in order to obtain a list LD1d of durations shifted by one row. The maximum shift for a shifted list is a shift of n rows by removing the n first terms of the duration lists for a group of order n.

Thus, a variable from a set of a group is compared with a variable in each of the other sets of the same group, and in the case of identity, the sets including the variables having identical lists, and for example LD1d of one of the variables and LD2 of the second variable, are united.

The comparison between sets of a same group is also performed by calculating duration sum lists LSD in order to unite the sets together once again.

These lists are obtained by adding, for a group of order n, the first n terms of the duration lists, the value of which becomes that of the first term of the duration sum list LSD and then by continuing with the following n terms until there remains less than n terms in the duration list.

By taking as an example, the variable Mo which is found in a group of order 2 and with LD1 (Mo)=6, 11, 6, 16, 6, the duration sum list LSD1 is equal to 17, 22.

The comparison between sets of a same group is also performed by calculating shifted duration sum lists LSDd which are obtained from the duration sum lists in the same way as the shifted duration lists from the duration lists D1 and/or D2. The maximum shift for a shifted sum list is n rows by removing the first n terms of the duration lists for a group of order n.

Thus, one variable belonging to a set is compared with another variable for each other set of the same group by comparing:
the LD1, LD1d, and/or LD2, LD2d shifted duration list terms of one variable with the terms of the LD1 and/or LD2 lists of the other variable,
the terms of the LSD1 and/or LSD2 duration sum lists and of the LSD1d and/or LDS2d shifted duration sum lists of one variable with the LSD1 and/or LSD2 lists of the other variable in order to unite the sets of a same group, the variables of which are linked.

The processing step also comprises an operation for comparing the sets of a group with the sets of each other group, and the union of the sets in a group when two variables each belonging to one of the sets, are linked.

For this purpose, one variable belonging to a set of a group is compared with another variable of each set of each other group by comparing:
the terms of the LSD1 and/or LSD2 duration sum lists and of the LSD1d and/or LDS2d shifted duration sum lists of one of the variables with the LD1 or LD1d or LSD1 and/or LD2 or LD2d or LSD2 lists of the other variable.

By again taking the described example, this allows the sets EN1, EN3 and EN4 to be united into a group from comparisons of variables De and m.

Set EN1 belongs to a group of order 1 and LD2(b)=17, 22, 20.

Set EN3 belongs to a group of order 2 and LD1(De)=(4, 13, 4, 18, 4, 16, 4), a list LSD1d, a duration sum list D1 shifted by one row, equal to 17, 22, 20 is obtained for variable De.

Set EN4 belongs to a group of order 3 and LD2(m)=(4, 4, 9, 4, 4, 14, 4, 4, 12), a duration D1 sum list LSD1(m) equal to 17, 22, 20 is thereby obtained for variable m.

Therefore LD2(b) is identical with LSD1d(De) identical with LSD1(m).

A first group grouping sets EN1, EN3 and EN4, i.e., variables b, pp, h, De, Mo and m, and a second group consisting of set EN2 i.e., variables pf, Av, Rec, a and r, are therefore obtained.

Therefore two groups are obtained, each corresponding to at least one subunit of the system with the first group for the “drill” subunit and the second group for the “milling machine” subunit.

At this level, it should be reported that a group may contain variables corresponding to several subunits, the operations of which are linked. In order to discriminate these subunits, the method, in an alternative embodiment, comprises a step for stopping or changing the operation of one or more subunits so as to distinguish the variables of one subunit with respect to another subunit, the operating cycles of which are linked. Provision may also be made for discriminating the subunits by constantly monitoring the system in its operation, and by waiting for failures of the subunits of the latter.

The classification method further comprises a step for tracking the beginning and the end of the operating cycle of each group. Said tracking step may be performed in various ways, from the groups obtained from the earlier steps and the duration lists D1 and D2 of the different variables.

According to the method, tracking is performed for each group:
by determining the x most significant durations between the change of state of one variable of one group and the following change of state of another variable of the same group,
by determining for each of the x durations the states of the set of the variables of the relevant group,
by selecting the most frequent case including the most or least significant number of variables in an E1 or E2 state,
by considering that this case when it exists, gives the end-of-operating-cycle variables of the group.

FIG. 6 schematically illustrates an exemplary embodiment of the step for tracking operating cycles of each group.

According to the example of FIG. 6, a classification operation in each set of variables according to their order of appearance for example state El, is performed for tracking.

In the example of the facility 1, the order of appearance of the variables, for the first group, is the following: pp, De, m, Mo, h and b.

The method consists of then performing the selection of a given number of the most significant durations D1 or D2 of the group. Again taking the example of facility 1, the most significant durations D1 are 22, 20 and 17.

The method then consists of calculating time jumps between the appearance of each new variable of the set by examining the moment when the duration between two consecutive passages for the first variable which has appeared is one of the selected durations and by repeating the calculation for the set of selected durations. With reference to the time diagram of FIG. 4, it is seen that for variable pp, the duration D1 of 22 between two variables pp in the E1 state, begins at moment 17.

The method then consists of recording the states (E1) or (E2) of each variable associated with the most significant time jumps calculated for each of the selected durations. In the facility 1 for the first group and for durations D1=22 and then 20 and 17, variables pp are again found in a state E2, Mo in a state E2 and h in a state E1 every time before the most significant duration jump.

After the most significant duration jump for each selected duration D1, the variables pp are again found in a state E1, De in a state E1 and h in a state E2.

The method then consists of selecting the most frequent case wherein the minimum number of variables is in a state (E1) or in a state (E2) in order to determine the beginning and the end of the group's cycle. In the case of facility 1, the minimum number of variables in state E1 will be selected.

Considering that, for the first group, the same result is obtained for the three selected durations D1, the cycle of this group begins when the variables pp are in a state E1, De in a state E1 and h in a state E2, and the cycle ends when the variables pp are in a state E2, Mo in a state E2 and h in a state E1.

It is important to note that, in the case when there is no most frequent case, it will be possible to inform the operator on the different cases obtained by the method for the beginnings and ends of cycle for each group with, in a preferred embodiment, the frequency percentages for each of these cases.

For the second group, by proceeding as for the first group, a most frequent case is also obtained with which a beginning of cycle may be inferred when the variables pf and Av are in an E1 state and variable r in an E2 state, and an end of cycle when the variables Rec and pf are in an E2 state and r in an E1 state.

From the data for the beginning and the end of cycle and from the different durations D1, it is further possible to calculate the durations of the operating and working cycles. The operating cycle duration according to a preferred embodiment is determined from a variable for the beginning of a cycle belonging to a group of order n and by calculating its n+1^{th} appearance in the state in which it was found at the beginning of the cycle.

In the facility 1, variable h is taken for example, which belongs to a group of order 2 and which appears for the first time at the beginning of the cycle in a state E2. The duration between the appearance of this variable at the beginning of the cycle and its third appearance in the E2 state, is equal to the duration of the operating cycle.

The working cycle duration is itself determined, preferably from a variable of the beginning of the cycle belonging to a group of order n, and by calculating its n^{th} appearance in the state opposite to the one in which it was found at the beginning of the cycle. The actual cycle time may also be determined for each subunit, the actual cycle time corresponding to the smallest D1 of a variable of the subunit larger than the working cycle duration.

By again taking variable h, the working cycle duration is the duration between the appearance of the state E2 of this variable at the beginning of the cycle, and its second appearance in the state E1.

The actual cycle time is the smallest operating cycle larger than the working cycle duration.

In this way, an operating cycle duration of 17 and a working cycle duration of 12 are obtained for the first group.

In the same way, an operating cycle duration of 17 and a working cycle duration of 12 are obtained for the second group.

With the classification method, it is thereby not only possible to classify variables in groups corresponding to at least one subunit of the system but it is further possible to determine for each group the beginnings and the ends of the operating cycle as well as the duration of the operating and working cycles.

It is important to note that with the classification method it is also possible to take into account numerical variables with more than two states in order to determine the subunits to which belong these variables. For this purpose, a step is performed wherein a given number of two-state variables is created from a numerical variable with more than two states, so as to classify said variables created in a group. As a non-limiting example, four two-state variables may be created for a numerical variable with more than two states, with the first variable switching for the numerical value passing through a maximum, a second variable switching for the numerical value passing through a minimum, a third variable switching for the numerical value passing through zero while increasing and a fourth variable switching for the numerical value passing through zero while decreasing.

Of course, other embodiments within the capacity of one skilled in the art might have been contemplated without however departing from the scope of the invention as defined in the claims hereafter.

1. A method for classifying two-state variables of a cyclically operating system including subunits characterized in that the following steps are performed:
a recording step wherein dated state changes are recorded for each of said variables during a determined time T,
a calculation step wherein, from the dated state changes and for each of the variables, the different durations (D1) between two consecutive passages to a first state (E1) on the one hand and the different durations (D2) between two consecutive passages to a second state (E2) on the other hand, are determined so as to create duration lists (LD1) and (LD2),
a processing step wherein, for each variable, the different duration lists (LD1) and/or (LD2) are compared to the different lists of durations (LD1) and/or (LD2) of the other variables and the number of occurrences thereof so as to classify said variables in groups each corresponding to at least one of the subunits of said system.

2. The classification method according to claim 1 wherein the following is performed in said processing step:
creation of at least one group of order n, each group including one variable or a set of variables having a close number of occurrences
creation in each of said at least one group of at least one set wherein the variables are linked,
comparison of each set in a same group and union of the sets when two variables each belonging to one of the sets are linked,
comparison of the sets of one group with the sets of each other group and union of the sets when two variables each belonging to one of the sets are linked.

3. The classification method according to claim 2, wherein, after the creation of at least one group, elimination of the variables out of the operating cycle of the system is further achieved.

4. The classification method according to any of claims 2 and 3 wherein, in each group, the terms of the lists (LD1) and/or (LD2) of one variable are compared with the terms of the duration lists (LD1) and/or (LD2) of the other variables of the same group in order to create a set for each set of linked variables.

5. The classification method according to any of claims 2 to 4, wherein one variable belonging to a set is compared with another variable for each other set of the same group, by comparing:
the terms of the shifted duration lists (LD1, LD1d) and/or (LD2, LD2d) of one variable with the terms of the lists (LD1) and/or (LD2) of the other variable,
the terms of the duration sum lists (LSD1) and/or (LSD2) and of the shifted duration sum lists (LSD1d) and/or (LSD2d) of one variable with the lists (LSD1) and/or (LSD2) of the other variable in order to unite the sets of a same group, the variables of which are linked.

6. The classification method according to any of claims 2 to 4, wherein one variable belonging to a set of a group is compared with another variable of each set of each other group by comparing:
the terms of the duration sum lists (LSD1) and/or (LSD2) and of the shifted duration sum lists (LSD1d) and/or (LSD2d) of one variable with the lists (LD1, LD1d, LSD1) and/or (LD2, LD2d), LSD2) of the other variable in order to unite in a group, the sets, the variables of which are linked.

7. The classification method according to any of the preceding claims, wherein a step is performed for stopping or changing the operation of one or more subunits in order to distinguish the variables of a subunit with respect to another subunit, the operating cycles of which are linked.

8. The classification method according to any of the preceding claims, wherein a step for tracking the beginning and the end of the operating cycle of each group is further performed.

9. The classification method according to the preceding claim 8, wherein the tracking step for each group is performed:
by determining the x most significant durations between the change of state of one variable of a group and the following change of state of another variable from the same group,
by determining for each of the x durations, the states of the set of the variables of the relevant group,
by selecting the most frequent case including the most or the least significant number of variables in a state E1 or E2,
by considering that this case, if it exists, gives the variables for the end of operating cycle of the group.

10. The classification method according to the preceding claim 8, wherein the following is performed in said tracking step:
classification in each group of the variables according to their order of appearance,
selection of a given number of the most significant durations (D1) or (D2) of the group,
calculation of the time jumps between the appearance of each new variable of the group by examining the moment when the duration between two consecutive passages for the first variable which has appeared is one of the selected durations and by repeating the calculation for the set of selected durations,
recording the states (E1) or (E2) of each variable associated with the most significant time jump calculated for each of the selected durations,
selection of the most frequent case wherein the minimum number of variables are in a state (E1) or in a state (E2) in order to determine the beginning and the end of the cycle of the group.

11. The classification method according to any of the preceding claims, wherein from a numerical variable with more than two states, a given number of two-state variables are created, said created variables being classified into a group in order to determine the subunits to which the numerical variable with more than two states belongs.

12. A classification device for implementing the method according to any of the preceding claims 1 to 11, characterized in that it comprises:
recording means for recording and dating the state changes of each of said variables during a determined time corresponding to at least two operating cycles of said system,
calculation means for determining from the dated state changes and for each of the variables, the different durations D1 between two consecutive passages to a first state (E1) of a variable on the one hand, and the different durations (D2) between consecutive passages to a second state (E2) of a variable on the other hand,
processing means for comparing for each variable, the different durations (D1) and/or (D2) to the different durations (D1) and/or (D2) of the other variables, and the number of occurrences thereof, so as to classify said variables in groups each corresponding to at least one of the subunits of said system.

13. The use of the method according to any of the preceding claims 1 to 11, for systems of industrial facilities driven by controllers.
